(19) United States
(12) Patent Application Publication
(10) Pub. No.: US 2024/0027060 A1
(43) Pub. Date: Jan. 25, 2024

(54) INTERIOR LIGHTING FOR VEHICLE

(71) Applicant: Yazaki Corporation, Tokyo (JP)

(72) Inventors: Takayuki IKEDA, Shizuoka (JP); Takashi WAKASUGI, Shizuoka (JP)

(73) Assignee: Yazaki Corporation, Tokyo (JP)

(21) Appl. No.: 18/354,230

(22) Filed: Jul. 18, 2023

(30) Foreign Application Priority Data
Jul. 25, 2022 (JP) 2022-117999

(51) Int. Cl. F21V 33/00; B60Q 3/74; G01S 13/04; G01S 7/02; F21V 3/04

(52) U.S. Cl. CPC F21V 33/00; B60Q 3/74; G01S 13/04; G01S 7/027; F21V 3/04

(57) ABSTRACT

An interior lighting for vehicle includes a housing installed in an interior of a vehicle and including a radar-wave-transmittable portion configured to transmit radar waves and including a light transmittable part in the radar-wave-transmittable portion, a light emission unit installed in the housing and configured to emit visible light and configured to illuminate the interior of the vehicle by the emitted visible light coming out from the housing through the light transmittable part, and a radar unit installed in the housing and configured to emit radar wave and configured to detect a presence of a person in the interior of the vehicle by the radar wave transmitted from the radar-wave-transmittable portion.

### CROSS REFERENCE TO RELATED APPLICATION

The present application is based on, and claims priority from the prior Japanese Patent Application No. 2022-117999, filed on Jul. 25, 2022, the entire contents of which are incorporated herein by reference.

### TECHNICAL FIELD

The present disclosure relates to an interior lighting for vehicle.

### RELATED ARTS

Conventionally, an interior lighting device for vehicle is known that captures a driver's face with an infrared camera and determines a direction in which a driver looks (see JP 2008-81053 A). The interior lighting device for vehicle is designed to light a corresponding lighting device when the determined direction in which the driver looks is within a lighting range of at least one lighting device in the lighting device group.

### SUMMARY

However, since a detection range of an infrared camera is narrow in the conventional interior lighting device, a blind spot cannot be detected. Therefore, an applications such as the lighting of the aforementioned lighting system are limited.

An object of the present disclosure is to provide an interior lighting for a vehicle that enables to detect a person or the like in an interior with almost no blind spot in the interior of the vehicle.

A interior lighting for vehicle according to one or more embodiments include a housing installed in an interior of a vehicle and including a radar-wave-transmittable portion configured to transmit radar waves and including a light transmittable part in the radar-wave-transmittable portion, a light emission unit installed in the housing and configured to emit visible light and configured to illuminate the interior of the vehicle by the emitted visible light coming out from the housing through the light transmittable part, and a radar unit installed in the housing and configured to emit radar wave and configured to detect a presence of a person in the interior of the vehicle by the radar wave transmitted from the radar-wave-transmittable portion.

### BRIEF DESCRIPTION OF THE DRAWINGS

FIG. 1 is a diagram illustrating a vehicle in which an interior lighting for a vehicle according to one or more embodiments are installed,

FIG. 2 is an enlarged view of a location in which the interior lighting for the vehicle according to the one or more embodiments are installed,

FIG. 3 is a perspective view of the interior lighting for the vehicle according to the one or more embodiments,

FIG. 4 is an exploded perspective view of the interior lighting for the vehicle according to the one or more embodiments,

FIG. 5 is a view illustrating a V-V line cross section in FIG. 3,

FIG. 6 is a view illustrating an installation mode of a busbar in the interior lighting for the vehicle according to some embodiments, and

FIG. 7 is a view illustrating another installation mode of the busbar in the interior lighting for the vehicle according to some embodiments.

### DETAILED DESCRIPTION

Various embodiments will be described hereinafter with reference to the accompanying drawings.

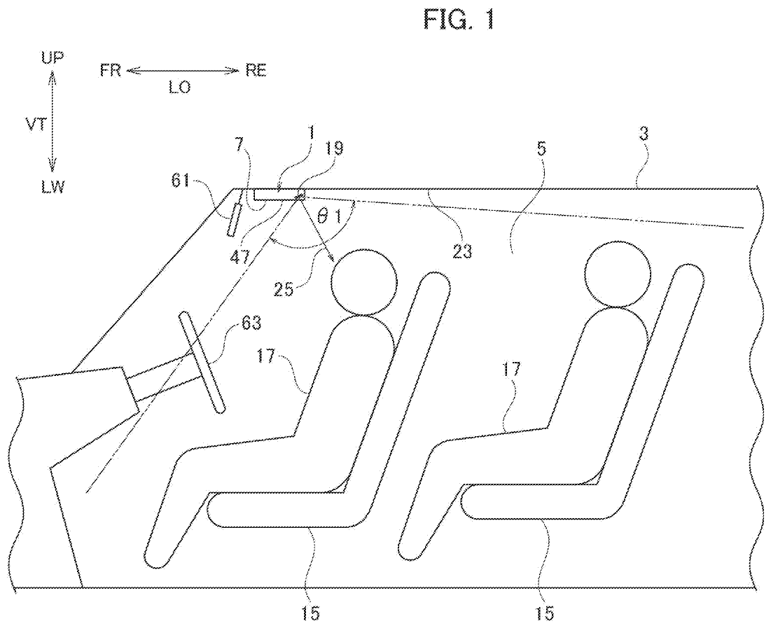

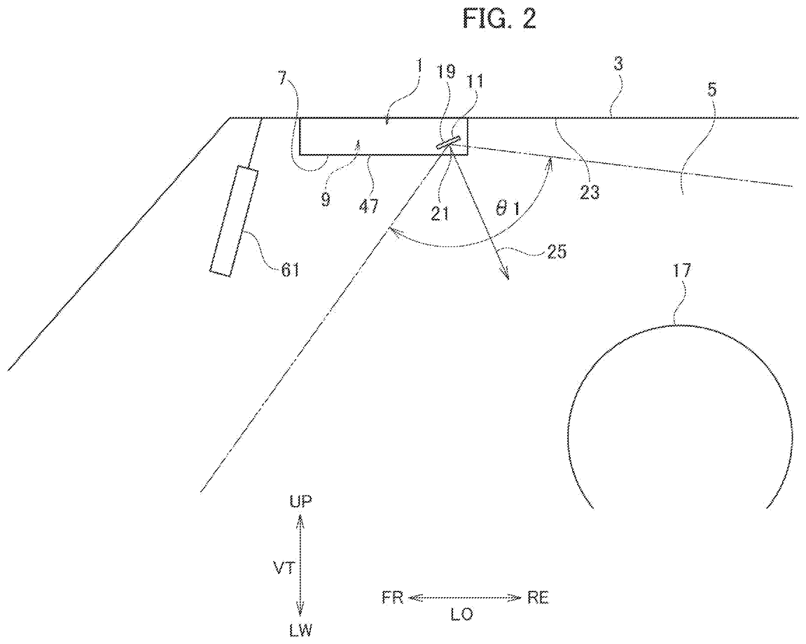

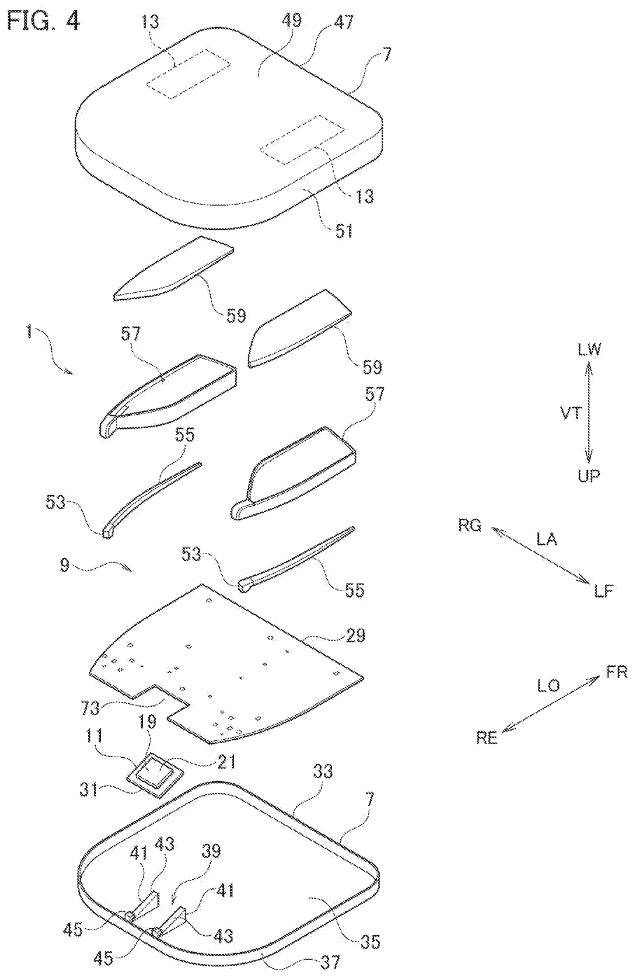

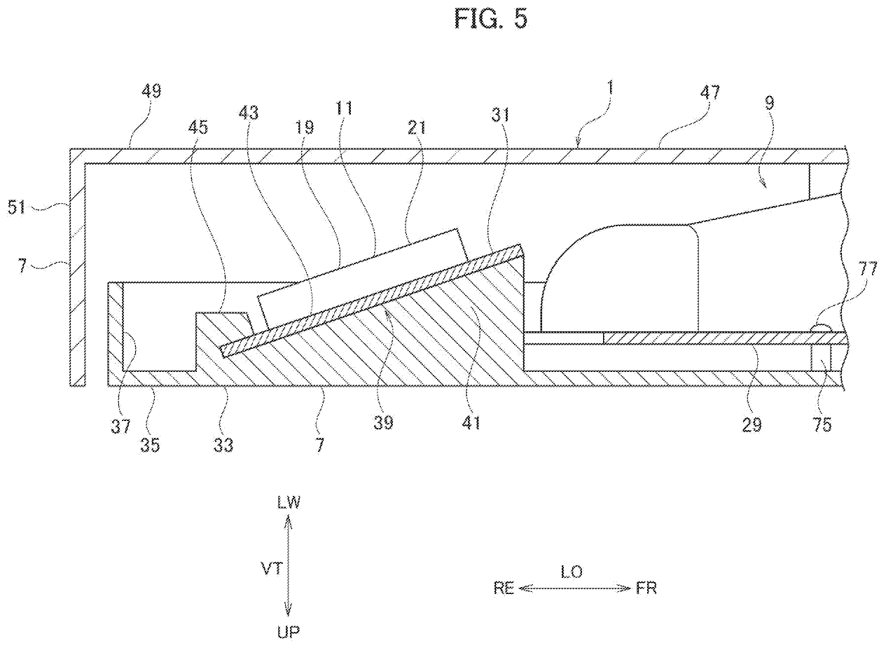

An interior lighting 1 for vehicle according to one or more embodiments are an interior lighting device for a vehicle with radar. As illustrated in FIGS. 1 and 2, the interior lighting 1 for vehicle is installed and used in an interior 5 of a vehicle 3. As illustrated in FIGS. 4 and 5, the interior lighting 1 for vehicle includes a housing 7, a light emission unit 9, and a radar unit (radar module) 11.

In FIGS. 1 and 2, the radar unit 11, which should be indicated by a dashed line, is indicated by a solid line for better visibility.

Here, for the convenience of explanation, a given horizontal direction is referred to as a front-rear direction LO. Another given horizontal direction perpendicular to the front-rear direction LO is referred to as a left-right direction LA. A direction perpendicular to the front-rear direction LO and the left-right direction LA is referred to as a vertical direction VT.

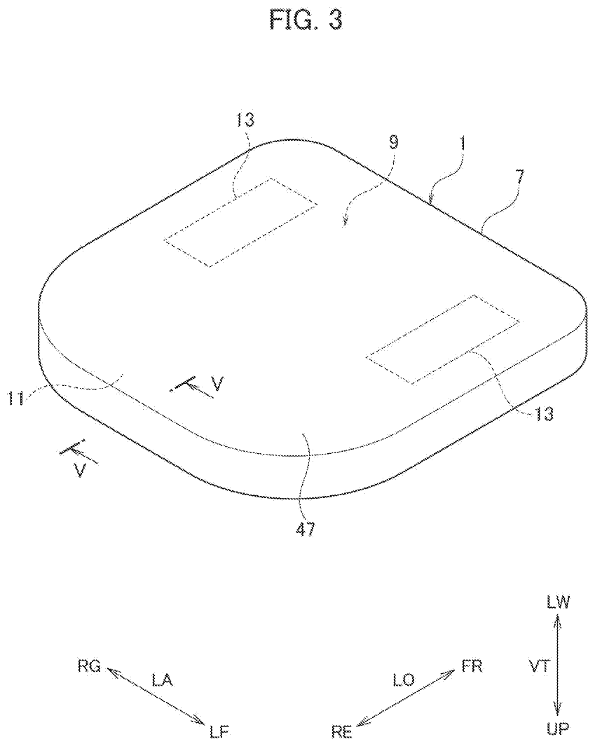

At least a part of the housing 7 is a radar-wave-transmittable portion where radar waves are transmittable, and the housing 7 is installed in the interior 5 of the vehicle 3. At least the part (e.g., all) of the housing 7 is made of a synthetic resin through which the radar waves are transmitted. In other words, the part of the housing 7 made of the synthetic resin is the radar-wave-transmittable portion mentioned above, and in some embodiments in which the whole of the housing 7 is made of the synthetic resin, the whole of the housing 7 works as the radar-wave-transmittable portion. Moreover, at least a part of the synthetic resin of the housing 7 is made to be a light transmittable part 13 (see FIG. 3) which is transparent or translucent through which visible light transmit.

The light emission unit 9 is installed in the housing 7 to emit visible light. Visible light emitted by the light emission unit 9 passes through the light transmittable part 13 among the radar-wave-transmittable portion and comes out of the housing 7 to illuminate the interior 5 of the vehicle 3.

The radar unit 11 is also installed in the housing 7. The radar unit 11 is provided to detect a person 17 present in the interior 5 of the vehicle 3. The presence of the person 17 in the interior 5 of the vehicle 3 can be detected by a radar wave emitted by the radar unit 11 and a reflected wave of the radar wave emitted by the radar unit 11 transmitted through the radar-wave-transmittable portion.

As the radar unit 11, for example, a phased array radar is employed. In addition, a detection range of the radar unit 11 covers almost the entire interior 5 of the vehicle 3, while the exterior of the interior 5 of the vehicle 3 is outside the detection range of the radar unit 11.

To further explain, the radar unit 11 can detect almost the entire body of every person 17 seated on seats 15 of the vehicle 3.

The radar unit 11 is designed to detect changes in a surface morphology (shape) of a skin of the person 17. To further explain, the radar unit 11 is designed to detect the presence of the person 17 in the interior 5 of the vehicle 3 by detecting the skin (skin) of the person 17 that is moist with a little moisture. The radar unit 11 is also designed to detect a presence of animals (for example, pets such as dogs and cats) in the interior 5 of the vehicle 3 by detecting skin of non-human animals.

In addition, electromagnetic waves with a frequency of 60 GHz are used as radar waves emitted by the radar unit 11. However, as the radar wave emitted by the radar unit 11, electromagnetic waves with a prescribed frequency between 40 GHz and 70 GHz may be used.

The radar unit 11 includes an antenna 19. The antenna 19 is formed in a flat plate shape. One plane 21 in a thickness direction of the antenna 19 is configured to emit radar waves and configured to capture reflected waves of the emitted radar waves.

When the interior lighting 1 for vehicle is integrally installed in, for example, the ceiling 23 of the interior 5 of the vehicle 3, a normal vector 25 is directed to a center of the interior 5 of the vehicle 3 as illustrated in FIGS. 1 and 2. The normal vector 25 is a normal vector of the one plane 21 in the thickness direction of the antenna 19. The normal vector 25 is the normal vector starting from a center of the one plane 21 in the thickness direction of the antenna 19.

Although not illustrated, the normal vector 25 is located in the center of the interior 5 of the vehicle 3 when viewed in the front-rear direction LO. On the contrary, when viewed in the left-right direction LA, the direction of the normal vector 25 differs depending on the location of the interior lighting 1 for vehicle in the front-rear direction LO. Although there are various configurations regarding the location and installation attitude of the interior lighting 1 for vehicle, in each configuration the normal vector 25 is directed to the center of the interior of the vehicle 3.

Following is an example in which the interior lighting 1 for vehicle is installed on the ceiling 23 of the interior 5 of the vehicle 3 at a front FR of the interior 5 of the vehicle 3. In this state, the normal vector 25 extends downward (directly downward) from the one plane 21 in the thickness direction of the antenna 19 as viewed in the front-rear direction LO. In addition, the normal vector 25 of the one plane 21 in the thickness direction of the antenna 19 extends obliquely downward and backward as viewed in the left-right direction LA as illustrated in FIG. 1. To explain further, the normal vector 25 intersects at a predetermined crossing angle with respect to the vertical direction VT as viewed in the left-right direction LA, with a start point located at the front FR and an end point located at a rear RE.

The antenna 19 of the radar unit 11 is fixed to the housing 7 so as not to move with respect to the housing 7 and so as not to change the attitude with respect to the housing 7. Therefore, in a state where the interior lighting 1 is integrally installed on the ceiling 23 of the interior 5 of the vehicle 3 at the front FR of the interior 5 of the vehicle 3, the antenna 19 of the radar unit 11 is fixed on the ceiling 23 of the vehicle 3. That is, the antenna 19 is fixed on the ceiling 23 of the vehicle 3 so that it does not move with respect to the vehicle 3 and the attitude with respect to the vehicle 3 does not change.

Herein, the interior lighting 1 for vehicle will be described in more detail.

The housing 7 is configured with a cover 33 and a panel 47 as illustrated in FIG. 4. The cover 33 is formed in a substantially rectangular flat plate shape. The cover 33 is provided with a bottom plate part 35 whose thickness direction is in the vertical direction VT and a side plate part 37 which stands from the outer periphery of the bottom plate part 35 toward the lower LW. In other words, the cover 33 is formed in a shallow box shape.

The cover 33 is provided with a radar installation part 39, as illustrated in FIGS. 4 and 5. The radar installation part 39 includes at least one protrusion 41 and a board support protrusion 45. The radar installation part 39 is provided on a lower surface of the bottom plate part in the vertical direction VT, at a center of the bottom plate part 35 in the left-right direction LA, and near a rear end of the bottom plate part 35 in the front-rear direction LO.

The protrusion 41 is a main component of the radar installation part 39 and is formed in a small flat plate shape with triangular shape. The protrusion 41 has a thickness direction in the left-right direction LA, and slightly protrudes from the lower surface of the bottom plate part 35 toward the lower LW in the vertical direction VT by the standing height of the side plate part 37. The protrusion 41 is provided at the center of the bottom plate part 35 in the left-right direction LA and near the rear end of the bottom plate part 35 in the front-rear direction LO.

Furthermore, in one or more embodiments, the protrusion 41 is provided in a pair, and the pair of protrusions 41 are slightly separated from each other in the 5 left-right direction LA. In addition, as illustrated in FIG. 5, an upper end surface of each protrusion 41 (an area corresponding to a hypotenuse of the triangular shape) forms a slope 43. The slope 43 is sloped such that a front end of slope 43 is located on the lower side LW with respect to the 10 rear end of slope 43. The board support protrusion 45 slightly protrudes from the slope 43 toward the lower LW at the rear end of the slope 43 of each protrusion 41.

As illustrated in FIG. 4, etc., the radar unit 11 includes the antenna 19 and a circuit board 31 for the radar 15 unit 11. The antenna 19 is formed in a rectangular flat plate shape. The circuit board 31 for the radar unit 11 is formed in a rectangular flat plate shape, size of which is slightly larger than the size of the antenna 19.

The antenna 19 is integrally installed on the 20 circuit board 31 for the radar unit 11 so that the thickness direction of the antenna 19 and a thickness direction of the circuit board 31 aligned with each other. Also, in the radar unit 11, the plane opposite to the one plane 21 of the antenna 19 is in contact with one plane (first plane) in the thickness direction of the circuit board 31. When viewed in the thickness direction of the antenna 19 and the circuit board 31, the antenna 19 is located in a center of the circuit board 31.

The radar unit 11 is located so that, a surface on the other plane of the circuit board 31 in the thickness direction (a surface on the second side, a surface on upper UP side in FIG. 5) is in contact with the slopes 43 of the protrusions 41. In the radar unit 11, the rear end part of the circuit board 31 is supported between the protrusion 41 and the board support protrusion 45. Thus, the radar unit 11 is integrally installed on the cover 33. In a state the radar unit 11 is installed on the cover 33, the antenna 19 and the board support protrusion 45 are slightly apart from each other.

The panel 47 is formed in a substantially rectangular flat plate shape as illustrated in FIG. 4. The panel 47 is provided with a bottom plate part 49 whose thickness direction is in the vertical direction VT, and a side plate part 51 which stands upward UP from the outer periphery of the bottom plate part 49. In other words, the panel 47 is formed in a shallow box shape. The standing height of the side plate part 51 of the panel 47 is higher than the standing height of the side plate part 37 of the cover 33. Also, when the cover 33 and the panel 47 are viewed in vertical direction VT, the panel 47 is slightly larger in size than the size of the cover 33.

The housing 7 is obtained by installing the cover 33 on the panel 47. When the housing 7 is viewed in the vertical direction VT, the cover 33 is housed inside the panel 47. The cover 33 is also housed in the panel 47 when the housing 7 is viewed from either direction the left-right direction LA or the front-rear direction LO.

The bottom plate part 35 and side plate part 37 of the cover 33 and the bottom plate part 49 and the side plate part 51 of the panel 47 form an internal space of the housing 7 that is configured to contain the light emission unit 9 and the radar unit 11.

The light emission unit 9 includes a main board 29 and at least one light emitting element 53 such as LED. The main board 29 is formed in a rectangular flat plate larger than the circuit board 31. The main board 29 is installed in the housing 7 so that the thickness direction is in the vertical direction VT. As illustrated in FIG. 5, the main board 29 is installed integrally in the cover 33 using spacers 75 and bolts 77.

The main board 29 installed in the cover 33 is located close to the bottom plate part 35 of the cover 33 in the vertical direction VT. A dimension of the main board 29 in the left-right direction LA and the front-rear direction LO is slightly smaller than that of the bottom plate part 35 of the cover 33.

When viewed in the vertical direction VT, the main board 29 installed in the cover 33 is arranged inside the side plate part 37 with a frame shape of the cover 33. As illustrated in FIG. 4, the main board 29 installed in the cover 33 is provided with a rectangular cutout 73 to avoid interference with the radar installation part 39.

The interior lighting 1 for vehicle further includes at least one light guide prism 55, at least one reflector 57, and at least one output prism 59 as illustrated in FIG. 4. The light guide prism 55, the reflector 57, and the output prism 59 are integrally installed in the housing 7 in the internal space of the housing 7.

The light (visible light) emitted by the light emitting element 53 enters the light guide prism 55 and is emitted from the light guide prism 55. A part of the light emitted from the light guide prism 55 directly reaches the output prism 59 and is transmitted through the output prism 59. The rest of the light emitted from the light guide prism is reflected by the reflector 57 and reaches the output prism 59 and is transmitted through the output prism 59.

The light transmitted through the output prism 59 passes through the light transmittable part 13 of the panel 47 of the housing 7 and exits the housing 7. A part of the panel 47 other than the light transmittable part 13 is a light-opaque part that does not transmit visible light.

The light guide prism 55 is formed in an elongated rod shape that is elongated in the front-rear direction LO. The light emitting element 53 is installed at a rear end of the light guide prism 55. The light emitting element 53, the light guide prism 55, the reflector 57, and the output prism 59 are located between the main board 29 and the bottom plate part 49 of the panel 47 in the vertical direction VT.

The light emitting element 53, the light guide prism 55, the reflector 57, the output prism 59, and the light transmittable part 13 are provided in a pair. Each of the pair of light emitting element 53 and the like is located near the left and right ends of the housing 7.

In the interior 5 of the vehicle 3, as illustrated in FIGS. 1 and 2, a seat 15 where a person 17 sits, a rearview mirror 61 and a handle 63 are provided. For example, the interior lighting 1 for vehicle is installed on the ceiling 23 of the interior 5. The interior lighting 1 for vehicle is installed at a rear side RE of the rearview mirror 61 and in the vicinity of the rearview mirror 61. Furthermore, the interior lighting 1 for vehicle is installed in the center of the interior 5 of the vehicle 3 in the left-right direction LA.

When viewed in the left-right direction LA, the detection range of the radar unit 11 of the interior lighting 1 for vehicle is a range indicated by an angle θ1 as illustrated in FIGS. 1 and 2. The normal vector 25 is directed toward the center of the range indicated by the angle θ1. That is, the normal vector 25 is directed to an angle where the angle θ1 is bisected. Since the detection range of the radar unit 11 of the interior lighting 1 for vehicle is within the range indicated by the angle θ1, the radar unit 11 can detect almost the entire interior 5 of the vehicle 3. In addition, although not illustrated in the figure, the detection range of the radar unit 11 when viewed in the front-rear direction LO is also within the range that can detect almost the entire interior 5 of the vehicle 3.

For example, the main board 29 is provided with a control unit including a memory and a CPU. The control unit detects changes in the surface morphology (shape) of the skin of the person 17 by appropriately processing the reflected radar waves.

To give a specific example, the shape of a skin on a chest of the person 17 is detected multiple times at a predetermined short time interval, and obtain changes in the shape of the skin on the chest of the person 17 (changes due to heartbeat or breathing) through these detections. Detection of the condition of the heart or lungs of the person 17 in the interior 5 of the vehicle 3 is then performed. The results of detection of the surface of the skin of the person 17 by the radar unit 11 are displayed by a display device (not illustrated).

Like an interior lighting of a conventional vehicle, the light emission unit 9 of the interior lighting 1 for vehicle turns on or off when a switch (not illustrated) is operated by the person 17 or when the door of the vehicle 3 is opened or closed.

The radar unit 11 of the interior lighting 1 for vehicle starts detecting, for example, when a power of the vehicle 3 is turned on. The radar unit 11 may detect whether the power of the vehicle 3 is turned on or off. Alternatively, the radar unit 11 may start detecting before the power of the vehicle 3 is turned on but when the door of the vehicle 3 is opened. Alternatively, the radar unit 11 may start detecting when an acceleration greater than a predetermined magnitude applied to the vehicle 3 is detected by an acceleration sensor (not illustrated) while the power of the vehicle is turned off.

The interior lighting 1 for vehicle includes the light emission unit 9 that illuminates the interior 5 of the vehicle 3 by allowing emitted visible light to pass through the light transmittable part 13 of the housing 7. The interior lighting 1 for vehicle further includes the radar unit 11 that detects the presence of the person 17 in the interior 5 of the vehicle 3 by transmitting radar waves through the radar-wave-transmittable portion of the housing 7.

The detection range of the radar unit 11 is wider than that of the infrared camera. This makes it possible to detect the person 17 or the like in the interior 5 of the vehicle 3 by eliminating almost all blind spots in the interior 5 of the vehicle 3.

In addition, the light emission unit 9 and the radar unit 11 are provided in one housing 7. As a result, it is not necessary to separately supply electric power to the light emission unit 9 and the radar unit 11, and it is only necessary to supply electric power in the housing 7 to simplify the configuration and reduce the size of the interior lighting 1 for vehicle.

In addition, since electromagnetic waves with a frequency of 60 GHz are used as radar waves, it is possible to detect people 17 and others by penetrating obstacles such as resin (sheets 15, clothes of people 17, etc.) in the interior 5 of the vehicle 3.

In addition, since it is not necessary to provide an opening for sensor detection through which radar waves can penetrate in the housing 7 in which the radar unit 11, which is a design component, is built, the degree of freedom in design of the interior lighting 1 for vehicle is improved.

Furthermore, by mounting the radar unit 11 on the interior lighting 1 for vehicle as a lighting lamp, various sensing of the interior 5 of the vehicle 3 can be performed.

For example, a child left in the interior 5 of the vehicle 3 can be detected. An intruder in the interior 5 of the vehicle 3 can be detected. A human gesture in the interior 5 of the vehicle 3 can be detected. A sitting of the person 17 in the interior 5 of the vehicle 3 can be detected. Further, it is possible to perform cardiopulmonary detection of the person 17 in the interior 5 of the vehicle 3.

In the interior lighting 1 for vehicle, the radar unit 11 is designed to detect changes in the surface morphology (shape) of the skin of the person 17. With this, it is possible to detect almost the entire skin of the person 17 as well as the exposed parts (Face, head, hands, etc.) of the person 17 in the interior 5 of the vehicle 3. Thus, it is possible to accurately detect the movement and health of the person present in the interior 5 of the vehicle 3.

The radar unit 11 detects the presence of the person 17 in the interior 5 of the vehicle 3 by detecting the skin (skin) of the person 17. With this, the movement of the skin of the chest of the person 17 wearing clothes in the interior 5 of the vehicle 3 can be reliably detected, and the detection of whether or not the cardiorespiratory condition of the person 17 is normal can be made accurate.

With the interior lighting 1 for vehicle installed on the ceiling 23 of the interior 5 of the vehicle 3 at the front side FR of the interior 5 of the vehicle 3, the normal vector 25 of the one plane 21 in the thickness direction of the antenna 19 is directed to the center of the interior 5 of the vehicle 3. This enables detection of the entire interior 5 of the vehicle 3 by the radar unit 11 in a reasonable manner.

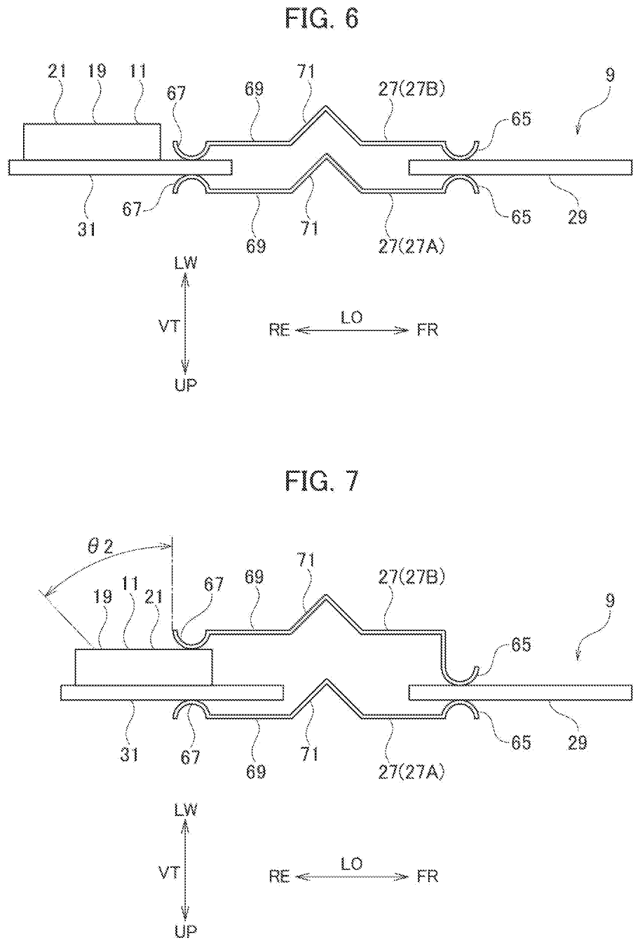

By the way, as illustrated in FIG. 6, a busbar (metal busbar) 27 may be provided in the housing 7 of the interior lighting 1 for vehicle. As described above, the main board 29 with plate shape is provided in the housing 7 of the interior lighting 1 for vehicle. The main board 29 is, for example, the a circuit board for the light emission unit 9.

The radar unit 11 includes the circuit board 31 having a flat plate shape and is separate from the main board 29. The antenna 19 of the radar unit 11 is integrally provided on one side in the thickness direction of the circuit board 31 of the radar unit 11. The busbar 27 couples the main board 29 with the circuit board 31. In other words, the busbar 27 connects the main board 29 to the circuit board 31 of the radar unit 11.

The busbar 27 may be provided for the supply of power from the main board 29 to the radar unit 11 (the circuit board 31 of the radar unit 11). The busbar 27 may also be provided for the transfer of signals between the main board 29 and the radar unit 11 (circuit board 31 of the radar unit 11). The busbar 27 may have both of these functions.

Further, in detail, the busbar 27 is formed by a plate-shaped material bent appropriately. The busbar 27 includes a main board contact part 65 configured to be in contact with the main board 29, a board contact part 67 configured to be in contact with the circuit board 31 of the radar unit 11, and a busbar body 69.

The main board contact part 65 extends from a front end of the busbar body 69 toward a front side FR. The board contact part 67 extends from a rear end of the busbar body 69 toward a rear side RE. A center of the busbar body part 69 is an attitude adjustment part 71. By providing the attitude adjustment part 71, the busbar body 69 is easily deformed elastically.

The busbar 27 is integrated with the housing 7 by being supported by the housing 7, for example. However, the busbar 27 may be supported by the main board 29 and the circuit board 31 of the radar unit 11.

As the busbar 27, for example, an upper busbar 27A and a lower busbar 27B are provided. The main board 29 and the circuit board 31 are sandwiched between the upper busbar 27A and the lower busbar 27B.

Assume that the main board 29 and the circuit board 31 are integrated into one board, for example, and that the light emission unit 9 and the antenna 19 of the radar unit 11 are mounted on the one board. Then, depending on an installation position, installation angle, or an installation attitude of the interior lighting 1 for vehicle, there will be places where the radar wave is not irradiated, and a detection accuracy of the radar unit 11 will be degraded.

However, in a configuration illustrated in FIG. 6, the main board 29 and the circuit board 31 of the radar unit 11 are separated and connected by a busbar 27. Thus, the attitude of the antenna 19 of the radar unit 11 mounted on the circuit board 31 can be adjusted. In addition, the antenna 19 of the radar unit 11 can be directed to a desired direction of detection regardless of the installation attitude of the light emission unit 9.

In addition, since the main board 29 and the circuit board 31 are separated and connected by the busbar 27, heat generated from the main board 29 and the circuit board 31 can be efficiently radiated from the busbar 27, etc. This prevents the radar unit 11 from being exposed to high temperatures and prevents the detection accuracy of the radar unit 11 from being degraded.

Furthermore, since the busbar 27 includes the upper busbar 27A and the lower busbar 27B, the heat generated from the main board 29 and the circuit board 31 can be radiated more efficiently.

In the configuration illustrated in FIG. 7, to narrow and limit the detection range of the radar unit 11, the busbar 27, specifically, a part of the lower busbar 27B, engages the radar unit 11. That is, a part of the busbar 27 covers a part of the one plane 21 in the thickness direction of the antenna 19 of the radar unit 11. This narrows the detection range of the radar unit 11 and limits it to the range indicated by an angle θ2.

Then, for example, the radar unit 11 is prevented from detecting at places other than the interior 5 of the vehicle 3. In a mode illustrated in FIG. 7, the upper busbar 27A may be provided in a same manner as that illustrated in FIG. 6.

A case of narrowing the detection range of the radar unit 11 will be explained further with an example. Two of the interior lightings 1 for vehicle are installed on the ceiling 23 of the interior 5 of the vehicle 3. The first interior lighting 1 for vehicle is installed in the center in the left-right direction LA and in the front side FR in the front-rear direction LO. The second interior lighting 1 for vehicle is installed in the center in the left-right direction LA and in the rear side RE in the front-rear direction LO.

The radar unit 11 of the interior lighting 1 for vehicle in the front side FR prevents a transmitted radar wave from reaching the rear side RE in the interior 5, limiting the detection range. The radar unit 11 of the interior lighting 1 for vehicle in the rear side RE prevents a transmitted radar wave from reaching the front side FR in the interior 5, limiting the detection range.

In the configuration illustrated in FIG. 7, a part of the busbar 27, which is made of metal and does not pass radar waves, engages the radar unit 11 to narrow the detection range of the radar unit 11. This simple configuration prevents the radar waves from being irradiated in places that need not be detected by the radar unit 11. In other words, it is designed not to detect areas that are desired to be outside the detection range of the radar unit 11, such as outside the interior 5 of the vehicle 3.

In addition, since the detection range of the radar unit 11 is narrowed by the busbar 27, mutual interference of radio waves is prevented when multiple radar units are installed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An interior lighting for vehicle comprising:
a housing installed in an interior of a vehicle and comprising a radar-wave-transmittable portion configured to transmit radar waves and including a light transmittable part in the radar-wave-transmittable portion;
a light emission unit installed in the housing and configured to emit visible light and configured to illuminate the interior of the vehicle by the emitted visible light coming out from the housing through the light transmittable part; and
a radar unit installed in the housing and configured to emit radar wave and configured to detect a presence of a person in the interior of the vehicle by the radar wave transmitted from the radar-wave-transmittable portion.

2. The interior lighting for vehicle according to claim 1, wherein
the radar unit is configured to detect changes in a surface morphology of a human skin.

3. The interior lighting for vehicle according to claim 1, wherein
an antenna of the radar unit is formed in a flat shape and is configured to emit radar waves in one plane in a thickness direction of the antenna and detect reflected waves of the emitted radar waves, and
in a state of being installed in the interior of the vehicle, a normal vector of the one plane in the thickness direction of the antenna is directed to a center of the interior of the vehicle.

4. The interior lighting for vehicle according to claim 1, the interior lighting for vehicle further includes:
a main board installed in the housing,
a circuit board for the radar unit installed in the housing, and
a busbar connecting the main board and the circuit board for the radar unit.

5. The interior lighting for vehicle according to claim 1, wherein
a busbar is installed in the housing, and
a part of the busbar is engaged with the radar unit to narrow a detection range of the radar unit.
